(19) United States
(12) Patent Application Publication
(10) Pub. No.: US 2015/0294473 A1
(43) Pub. Date: Oct. 15, 2015

(54) Processing of Depth Images

(71) Applicant: TELEFONAKTIEBOLAGET L M ERICSSON (PUBL), Stockholm (SE)

(72) Inventors: Julien Michot, Sundbyberg (SE); Ivana Girdzijauskas, Solna (SE)

(21) Appl. No.: 14/441,874

(22) PCT Filed: Nov. 12, 2012
(86) PCT No.: PCT/SE2012/051230

§ 371 Date: May 11, 2015

(51) Int. Cl. G06T 7/00; G06T 7/40

(52) U.S. Cl. CPC G06T 7/0059; G06T 7/408; G06T 2207/20228

(57) ABSTRACT

A method, an electronic device, a computer program and a computer program product relate to 3D image reconstruction. A depth image part (7) of a 3D image representation is acquired. The depth image part represents depth values of the 3D image. An area (9, 10) in the depth image part is determined. The area represents missing depth values in the depth image part. At least one first line (Pr) in a first neighbourhood (Nr) of the area is estimated by a first gradient of the depth values being determined in the first neighbourhood and a direction of the at least one first line being determined in accordance with the first gradient. Depth values of the area based on the at least one first line are estimated and the area is filled with the estimated depth values. The 3D image is thereby reconstructed.

### TECHNICAL FIELD

Embodiments presented herein relate to image processing, and particularly to 3D image reconstruction.

### BACKGROUND

The research in three dimensional (3D) imaging, such as 3D Video or 3D TV, has gained a lot of momentum in recent years. The term 3D is usually related to stereoscopic experiences, where each one of the user's eyes is provided with a unique image of a scene. Such unique images may be provided as a stereoscopic image pair. The unique images are then fused by the human brain to create a depth impression (i.e. an imagined 3D view).

A number of 3D movies are being produced every year, providing stereoscopic effects to the spectators. Also consumer 3D TV devices are available. It is also envisaged that 3D-enabled mobile devices (such as tablet computers and so-called smartphones) soon will be commercially available. A number of standardization bodies (ITU, EBU, SMPTE, MPEG, and DVB) and other international groups (e.g. DTG, SCTE), are working toward standards for 3D TV or Video.

Free viewpoint television (FTV) is an audio-visual system that allows users to have a 3D visual experience while freely changing their position in front of a 3D display. Unlike a typical stereoscopic TV, which enables a 3D experience to users that are sitting at a fixed position in front of the TV screen, FTV allows viewers to observe the scene from different angles, as if actually being part of the scene displayed by the FTV display. In general terms, the FTV functionality is enabled by multiple components. The 3D scene is captured by a plurality of cameras and from different views (angles)—by so-called multiview video. Multiview video can be efficiently encoded by exploiting both temporal and spatial similarities that exist in different views. However, even with multiview video coding (MVC), the transmission cost remains prohibitively high. This is why today only a subset (typically 2-3) of the captured multiple views typically is transmitted. To compensate for the missing information, depth and disparity maps can be used. From the multiview video and depth/disparity information virtual views can be generated at an arbitrary viewing position. In general terms, a depth map is a representation of the depth for each point in a texture expressed as a grey-scale image. The depth map is used to artificially render non-transmitted views at the receiver side, for example with depth image-based rendering (DIBR). Sending one texture image and one depth map image (depth image for short) instead of two texture images may be more bitrate efficient. It also gives the renderer the possibility to adjust the position of the rendered view. FIG. 1 provides a schematic illustration of a depth image part 7. The depth image part 7 comprises a number of different areas representing different depth values. One of the areas with known depth is illustrated at reference numeral 8. One area with unknown depth values due to objects being located outside the range of the depth sensor is illustrated at reference numeral 9. One area with unknown depth values within the range of the depth sensor is illustrated at reference numeral 10.

In general terms, using depth and disparity maps requires the use of a depth sensor in order to find depth map values and/or disparity map values. However, for certain depth sensors, objects that are too close or too far away from the depth sensor device cannot be “sensed”, resulting in that such objects do not have any depth information in the depth or disparity map. As noted above, an example of such an area is in FIG. 1 identified at reference numeral 9.

Additionally, configurations of structured-light-based devices (having an IR projector and an IR camera not located in the same position) generate occlusions of the background depth due to the foreground as only the foreground receives the projected pattern. Other issues such as non-reflective surfaces or the need to register the depth map to another viewpoint (with the same of different camera intrinsics) generate areas with missing depth values. As noted above, an example of such an area is in FIG. 1 identified at reference numeral 10.

One issue when the depth of an object is unavailable or incorrect is how to render a scene in such a way that the eye strain and consequently a bad 3D experience for the user is avoided. Imprecise depth maps translate to misplacement of pixels in the rendered view. This is especially noticeable around object boundaries, resulting in a noisy cloud to be visible around the borders. Moreover, temporally unstable depth maps may cause flickering in the rendered view, leading to yet another 3D artifact.

In the paper “Stereoscopic image inpainting using scene geometry” by A Hervieux, N Papadakis, A Bugeau et al. in the proceedings of the 2011 IEEE International Conference on Multimedia and Expo there is proposed an inpainting technique according to which the texture image is clustered into homogeneous color regions using a mean-shift procedure and where the depth of each region is approximated by a plane and then extended into the mask. The visible parts of each extended region are inpainted using a modified exemplar-based inpainting algorithm. A number of drawbacks associated with this approach have been identified. For example, one depth plane per color segment (after a color segmentation step) is computed. The proposed method is thereby sensitive to the image segmentation parameters. If there are two walls or objects with the same color, the two walls or objects will be merged into one plane, resulting in reduced approximation quality. For example, the proposed method is computationally complex and thus is unsuitable for applications such as 3D video conferencing that require real-time processing. For example, the proposed method cannot be applied to estimate depth of eventual far walls if the walls are located entirely in the depth hole area.

Hence, there is still a need for an improved 3D image reconstruction.

### SUMMARY

An object of embodiments herein is to provide improved 3D image reconstruction.

The inventors of the enclosed embodiments have through a combination of practical experimentation and theoretical derivation discovered that the missing depth pixel values of a scene that are too far away (or too close) from the depth sensor may be filled by approximating the missing values with one or more lines. The line parameters are obtained from neighboring available (i.e., valid) pixel values in the depth representation. This approach may also be used to fill missing depth of flat non-reflective surfaces (for example representing windows, mirrors, monitors or the like) in case the flat non-reflective surfaces are placed in-between two lines that are estimated to be equal or very close to equal.

A particular object is therefore to provide improved 3D image reconstruction based on estimating at least one first line.

According to a first aspect there is presented a method of 3D image reconstruction. The method comprises acquiring a depth image part of a 3D image representation. The depth image part represents depth values of the 3D image. The method comprises determining an area in the depth image part. The area represents missing depth values in the depth image part. The method comprises estimating at least one first line in a first neighbourhood of the area by determining a first gradient of the depth values in the first neighbourhood and determining a direction of the at least one first line in accordance with the first gradient. The method comprises estimating depth values of the area based on the at least one first line and filling the area with the estimated depth values, thereby reconstructing the 3D image.

Advantageously the reconstructed 3D image comprises a complete and accurate depth map that hence will improve the 3D viewing experience of the user.

Advantageously the depth of a scene that is outside the depth range of the depth sensor may be estimated only by using already existing depth information. Hence this removes the need to use another camera. Besides, the line-based approximation enables eventual corners (e.g. of a room) from the image to be accurately determined, thereby increasing the lines estimation quality and robustness. The original sensing range of the depth sensor may thereby be extended.

Advantageously the disclosed embodiments may also be applied in order to fill holes/areas that are due to flat non-reflective content within the range of the depth sensor such as windows, TV or computer screens and other black, metallic or transparent surfaces in a more accurate way than by simple linear interpolation.

Advantageously the disclosed embodiments allow for simple execution and may hence be implemented to be performed in real-time, unlike other state-of-the-art approaches. This enables implementation of applications such as 3D video conferencing.

According to a second aspect there is presented an electronic device for 3D image reconstruction. The electronic device comprises a processing unit. The processing unit is arranged to acquire a depth image part of a 3D image representation, the depth image part representing depth values of the 3D image. The processing unit is arranged to determine an area in the depth image part, the area representing missing depth values in the depth image part. The processing unit is arranged to estimate at least one first line in a first neighbourhood of the area by determining a first gradient of the depth values in the first neighbourhood and determining a direction of the at least one first line in accordance with the first gradient. The processing unit is arranged to estimate depth values of the area based on the at least one first line and filling the area with the estimated depth values, thereby reconstructing the 3D image

According to a third aspect there is presented a computer program for 3D image reconstruction, the computer program comprising computer program code which, when run on a processing unit, causes the processing unit to perform a method according to the first aspect.

According to a fourth aspect there is presented a computer program product comprising a computer program according to the third aspect and a computer readable means on which the computer program is stored. According to an embodiment the computer readable means is a non-volatile computer readable means.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic illustration of a depth image part;

FIG. 2 is a schematic diagram showing functional modules of an electronic device;

FIGS. 3-6 are schematic diagrams of scene configurations and depth maps;

FIG. 7 is a schematic illustration of detected edges;

FIG. 8 shows one example of a computer program product comprising computer readable means; and

FIGS. 9-11 are flowcharts of methods according to embodiments.

### DETAILED DESCRIPTION

The present disclosure will now be described more fully hereinafter with reference to the accompanying drawings, in which certain embodiments of the disclosure are shown. The present disclosure may, however, be embodied in many different forms and should not be construed as limited to the embodiments set forth herein; rather, these embodiments are provided by way of example so that this disclosure will be thorough and complete, and will fully convey the scope of the present disclosure to those skilled in the art. Like numbers refer to like elements throughout the description.

Embodiments presented herein relate to image processing, and particularly to 3D image reconstruction. In 3D imaging a depth map is a simple grayscale image, wherein each pixel indicates the distance between the corresponding pixel from a video object and the capturing camera. Disparity is the apparent shift of a pixel which is a consequence of moving from one viewpoint to another. Depth and disparity are mathematically related and can be interchangeably used. One common property of depth/disparity maps is that they contain large smooth surfaces of constant grey levels. This makes depth/disparity maps easy to compress.

It is possible to construct a cloud of 3D points from the depth map according to the expression Q=d*q*K⁻¹, where q is a 2D point (expressed in the camera coordinate frame in homogeneous coordinates), d its associated depth (measured by the depth sensor for instance), Q the corresponding 3D point in a 3D coordinate frame, and where the matrix K represents a pinhole camera model including the focal lengths, principal point, etc. In general terms, the pinhole camera model describes the mathematical relationship between the coordinates of a 3D point and its projection onto the 2D image plane.

The depth map can be measured by specialized cameras, e.g., structured-light or time-of-flight (ToF) cameras, where the depth is correlated respectively with the deformation of a projected pattern or with the round-trip time of a pulse of light. These depth sensors have limitations, some of which will be mentioned here. The first limitation is associated with the depth range: objects that are too close to or too far away from the depth sensor device will not result in any depth information. The range of a depth sensor is static and limited for the structured-light devices—for a typical depth sensor the depth range is typically from 0.8 m to 4 m. For the ToF cameras, the depth range generally depends on the light frequency used: for example, a 20 MHz based depth sensor gives a depth range between 0.5 m and 7.5 m with an accuracy of about 1 cm. Another limitation is associated with the specific configuration of structured-light-based devices (having an IR projector and an IR camera not located in the same position), which generates occlusions of the background depth due to the foreground as only the foreground receives the projected pattern. Other issues such as non-reflective surfaces or the need to register the depth map to another viewpoint may also generate areas with missing depth values.

The missing depth values are commonly referred to as holes in the depth map, hereinafter referred to holes of type 1. Areas that are out of range may typically cover larger portions in a depth map. Smaller holes, hereinafter referred to holes of type 2, may be caused by occlusion problems. Finally, even smaller holes, hereinafter referred to holes of type 3, may be due to measurement noise or similar issues. The smallest holes (type 3) may be filled by applying filtering techniques. However, larger holes (type 1 and 2) cannot be fixed by such methods and in order to fill holes of type 1 and type 2 information of the scene texture or geometry is usually required.

Inpainting is a technique originally proposed for recovering missing texture in images. In general terms, inpainting may be split into geometric-based approaches and so-called exemplar-based approaches. According to the former the geometric structure of the image is propagated from the boundary towards the interior of the holes, whereas according to the latter the missing texture is generated by sampling and copying the available neighboring color values. Inpainting can also be accomplished by combining a texture with the corresponding depth image.

A number of depth sensors exist. Some of the basic principles of different types of depth sensors will be discussed next. However, as the skilled person understands, the disclosed embodiments are not limited to any particular type of depth sensor, unless specifically specified.

As a first example, a 3D scanner is a device that is arranged to analyze a real-world object or environment to collect data on its shape and possibly its appearance (i.e. color). A 3D scanner may thus be used as a depth sensor. The collected data can then be used by the device to generate digital, three dimensional models. Many different technologies can be used to construct and build these 3D scanning devices; each technology comes with its own limitations, advantages and costs.

A second example includes structured-light based systems. When using structured-light based systems a narrow band of light is projected onto a three-dimensionally shaped surface which produces a line of illumination that appears distorted from other perspectives than that of the projector. This can be used for an exact geometric reconstruction of the surface shape (light section). The structured-light based system may be arranged to project random points in order to capture a dense representation of the scene. The structured-light based system typically also specifies whether a pixel has a depth that is outside the depth range max value with a specific flag. It also specifies if the system is not able to acquire a depth of a pixel with another specific flag. Typical structured-light based systems have a maximum limit range value of 3 or 4 meters depending on the mode that is activated.

A third example includes Time-of-Flight (ToF) camera based systems. A ToF camera is a range imaging camera system that is arranged to resolve distance based on the speed of light (assumed to be known) by measuring the time-of-flight of a light signal between the camera and the subject for each point of the image. The time-of-flight camera belongs to a class of scannerless light detection and ranging (LIDAR) based systems, where the entire scene is captured with each laser or light pulse (as opposed to point-by-point) with a laser beam, such as in scanning LIDAR systems. The current resolution for most commercially available ToF camera based systems is 320×240 pixels or less. The range is typically in the order of 5 to 10 meters. Depending on the device model, objects that are located outside the depth range will be given no depth (specific flag). Alternatively, some devices may replicate the depth of an object located outside the range to be inside the range, thereby providing an erroneous depth value. For instance, if an object is at 12 meters from the sensor (where the maximum depth of the sensor is 10 m), the depth value will given as 2 meters. For this latter type of ToF camera, it may me possible to detect such an erroneous configuration considering for instance, the received signal strength. Another disadvantage is the background light that may interfere with the emitted light and which hence may make the depth map noisy. Besides, due to multiple reflections, the light may reach the objects along several paths and therefore the measured distance may be greater than the true distance.

In contrast to ToF cameras, where the system illuminates a whole scene, a fourth example includes laser scanning systems which typically only illuminate a single point at once. This results in a sparse depth map. In this kind of depth map, a bunch of pixels are known to have no known depth.

The embodiments disclosed herein relate to 3D image reconstruction whereby holes in the depth map are filled by approximating the unknown 3D content (in the hole) with one or more lines or planes. The planes may be planes of a box. In order to obtain 3D image reconstruction there is provided an electronic device, a method performed in the electronic device, a computer program comprising code, for example in the form of a computer program product, that when run on an electronic device, causes the electronic device to perform the method.

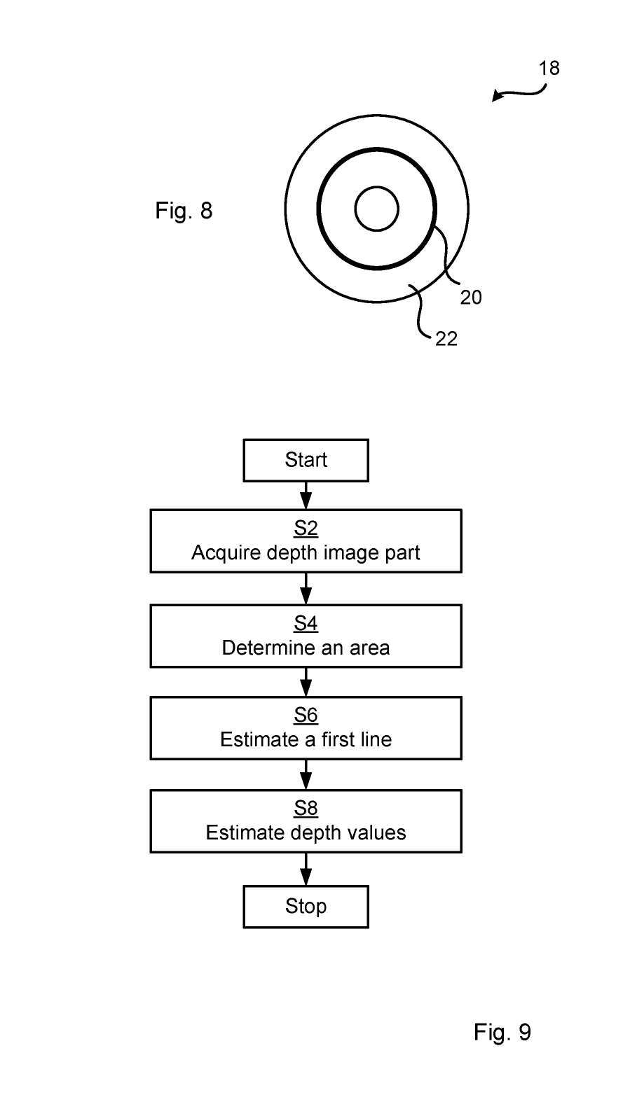

FIG. 2 schematically illustrates, in terms of a number of functional modules, the components of an electronic device 1. The electronic device 1 may be a 3D-enabled mobile device (such as a tablet computer or a so-called smartphone). Alternatively the electronic device 1 is part of a display device for 3D rendering. That is, the electronic device 1 may be part of a 3D video conferencing system. A processing unit 2 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 18 (as in FIG. 8), e.g. in the form of a memory 3. Thus the processing unit 2 is thereby arranged to execute methods as herein disclosed. In general terms the processing unit 2 may comprise a depth holes detector (DHD) functional block, a planes estimator (PE) functional block, and a depth map inpainter (DMI) functional block. According to embodiments the processing unit 2 may further comprise a depth map filter (DMF) functional block. The depth holes detector is arrange to detect areas representing holes in the depth map that are to be filled. The planes estimator is arranged to approximate the depth of the missing content (i.e. for a detected hole) by determining one or more lines using for instance neighboring depth information close to the hole to be filled. The depth map inpainter is arranged to use the lines approximation of the depth of the holes in order to fill the depth map.

The memory 3 may comprise persistent storage, which, for example, can be any single one or combination of magnetic memory, optical memory, solid state memory or even remotely mounted memory. The electronic device 1 may further comprise an input/output (I/O) interface 4 for receiving and providing information to a user interface and/or a display screen. The electronic device 1 may also comprise one or more transmitters 6 and/or receivers 5 for communications with other electronic devices. The processing unit 2 controls the general operation of the electronic device 1, e.g. by sending control signals to the transmitter 6, the receiver 5, the I/O interface and receiving reports from the transmitter 6, the receiver 5 and the I/O interface 4 of its operation. Other components, as well as the related functionality, of the electronic device 1 are omitted in order not to obscure the concepts presented herein.

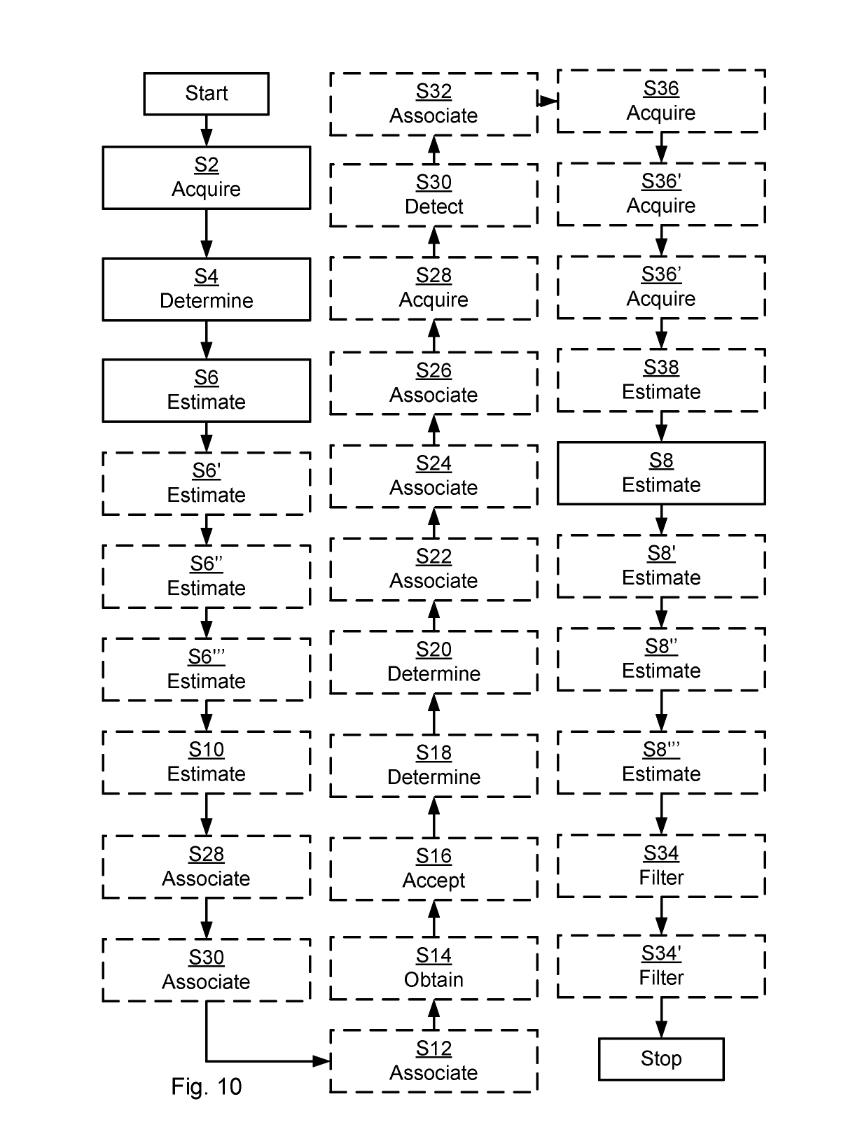

FIGS. 9 and 10 are flow charts illustrating embodiments of methods of 3D image reconstruction. The methods are performed in the electronic device 1. The methods are advantageously provided as computer programs 20. FIG. 8 shows one example of a computer program product 18 comprising computer readable means 22. On this computer readable means 22, a computer program 20 can be stored, which computer program 20 can cause the processing unit 2 and thereto operatively coupled entities and devices, such as the memory 3, the I/O interface 4, the transmitter 6, and/or the receiver 5 to execute methods according to embodiments described herein. In the example of FIG. 8, the computer program product 18 is illustrated as an optical disc, such as a CD (compact disc) or a DVD (digital versatile disc) or a Blu-Ray disc. The computer program product 18 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 20 is here schematically shown as a track on the depicted optical disk, the computer program 20 can be stored in any way which is suitable for the computer program product 18.

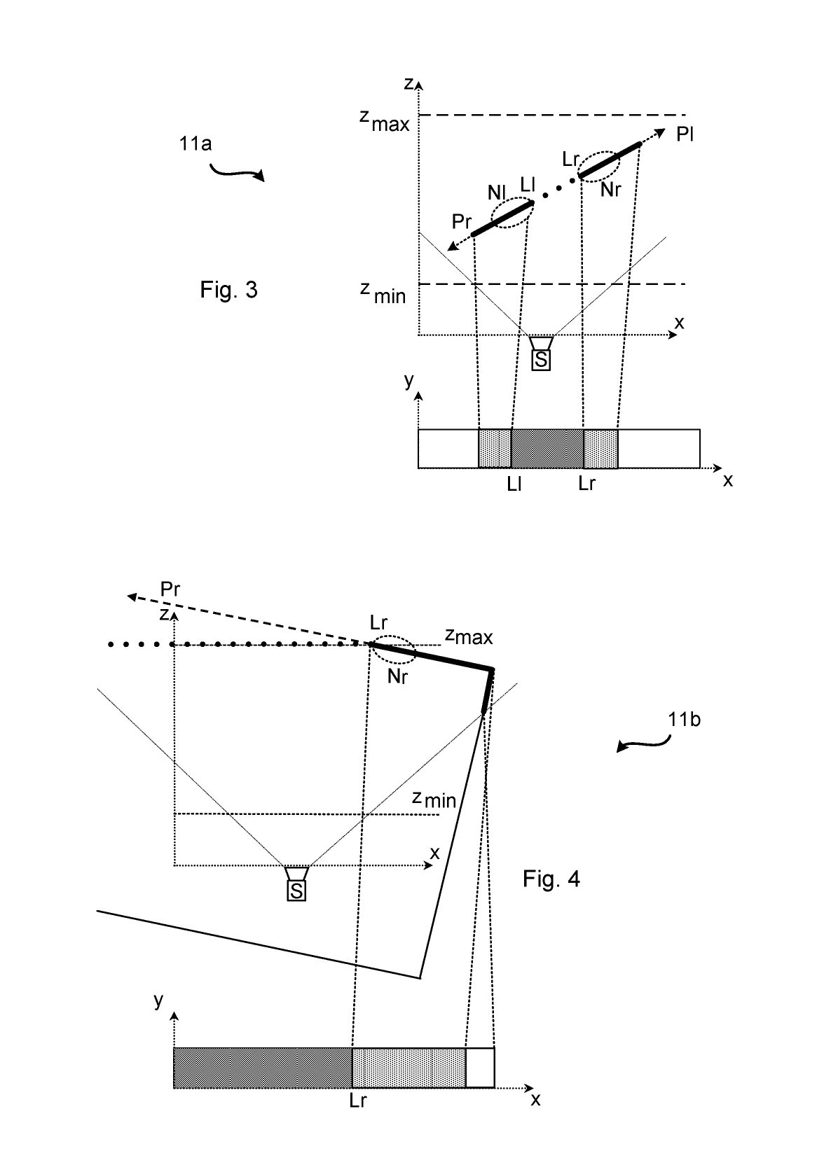

FIGS. 3-6 are schematic top views diagrams of scene configurations 11a, 11b, 11c, and lid and depth maps corresponding thereto. In each of FIGS. 3-6 a depth sensor S located geometrically according to each configuration has been used to estimate the depth map. The depth sensor S is located at the camera and its view angle is delimited by the two dotted black lines emanating from the camera. The depth range of the depth sensor (from Zmin to Zmax) is also illustrated. It is assumed that the depth sensor is only capable of providing valid depth values for content located in-between the two limits. Note that these figures are 2D slices of a scene containing a top view of the room. The corresponding depth maps depicted at the bottoms of the figures are 1D representations of these slices.

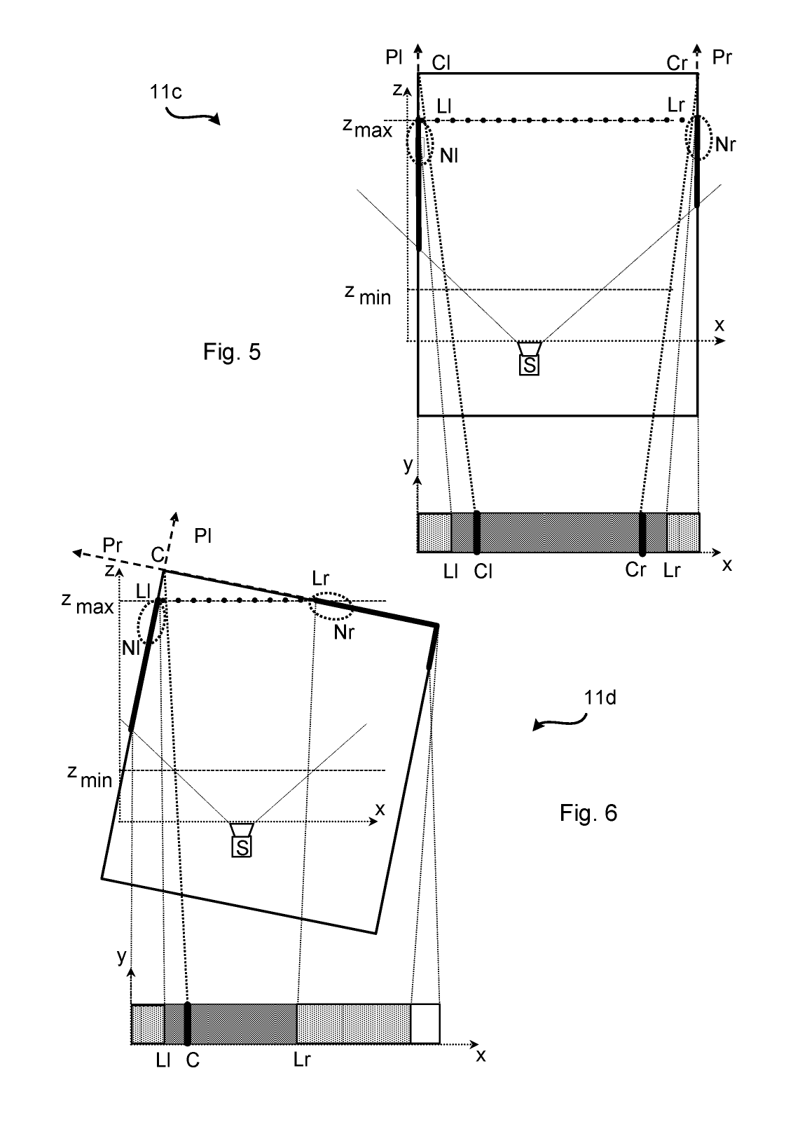

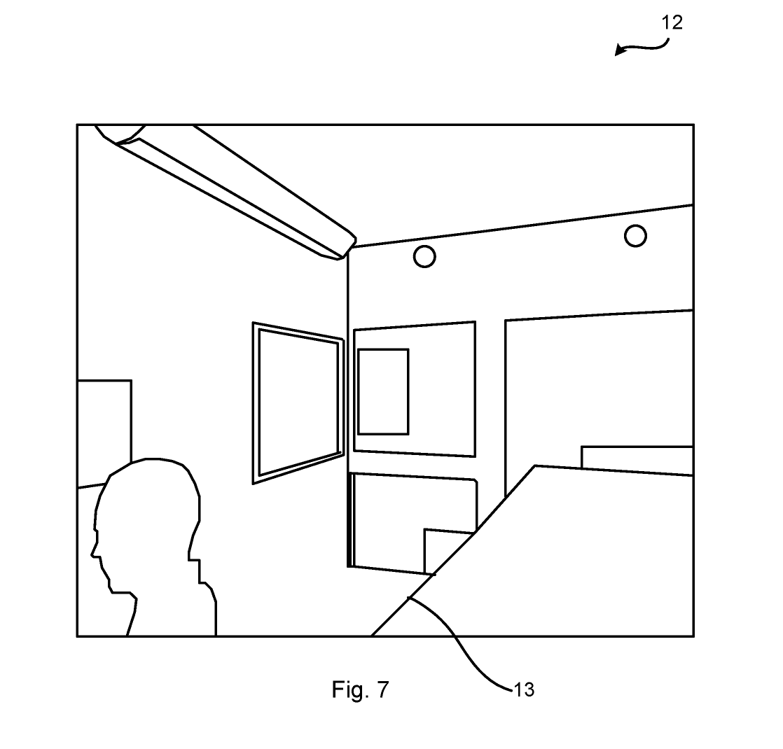

In FIGS. 3-6, bold continuous lines correspond to content for which the depth sensor S of the camera has correctly measured the depth. An illustration of the depth map returned by the depth sensor is given at the bottom of each FIG. 3-6. In the same figures, bold dotted lines represent holes (i.e. areas with missing depth values) due to a content located too far (Z>Zmax) from the depth sensor S (as in FIGS. 4, 5, and 6), or due to a non-reflective surface (as in FIG. 3). In the configuration 11a of FIG. 3 valid depth values for image content extending between Ll and Lr are missing. In the configuration 11b of FIG. 4 valid depth values are missing for image content extending from Lr towards the left (i.e., in negative direction along the x-axis). In the configuration 11c of FIG. 5 valid depth values are missing for image content extending between Ll and Lr. In the configuration 11d of FIG. 6 valid depth values are missing for image content extending between Ll and Lr.

The rectangles illustrated in FIGS. 5 and 6 (also partly in FIG. 4) may represent walls of a room. However, as the skilled person understands, the herein disclosed embodiments are not restricted only to be applied in an indoor setting or in scenarios comprising walls.

In each FIGS. 3, 5 and 6, Pl is the line that starts in the figures at Ll (i.e. at the last 3D point known before the hole starts on the left) and has the same direction as its neighboring 3D points Nl (illustrated as a dotted ellipse). In each FIGS. 3, 4, 5 and 6, Pr is the line that starts at Lr (i.e. at the first 3D point known before the hole finishes on the right) and has the same direction as its neighboring 3D points Nr (illustrated as a dotted ellipse). The direction of the arrow is given by the neighborhood evolution along the x-axis for this simplified and schematic configuration. According to embodiments at least one pixel of the first neighbourhood borders the area, and/or at least one pixel of the second neighbourhood borders the area. Although FIG. 3-6 show a view from the top and explain the line/plane estimation only in one dimension, it is clear that a certain 2D area may be used to estimate a plane or even a line. For example, for the width of the plane, pixels with available depth information that are within a 10 pixels distance from a hole may be considered. The size of the plane provides a trade-off between plane estimation complexity and plane accuracy and can be chosen based on the sequence type, shape of the hole etc.

Returning now to FIGS. 9 and 10, a method of 3D image reconstruction comprises in a step S2 acquiring a depth image part 7 of a 3D image representation. The depth image part 7 represents depth values of the 3D image. The depth image part is acquired by the processing unit 2 of the electronic device 1.

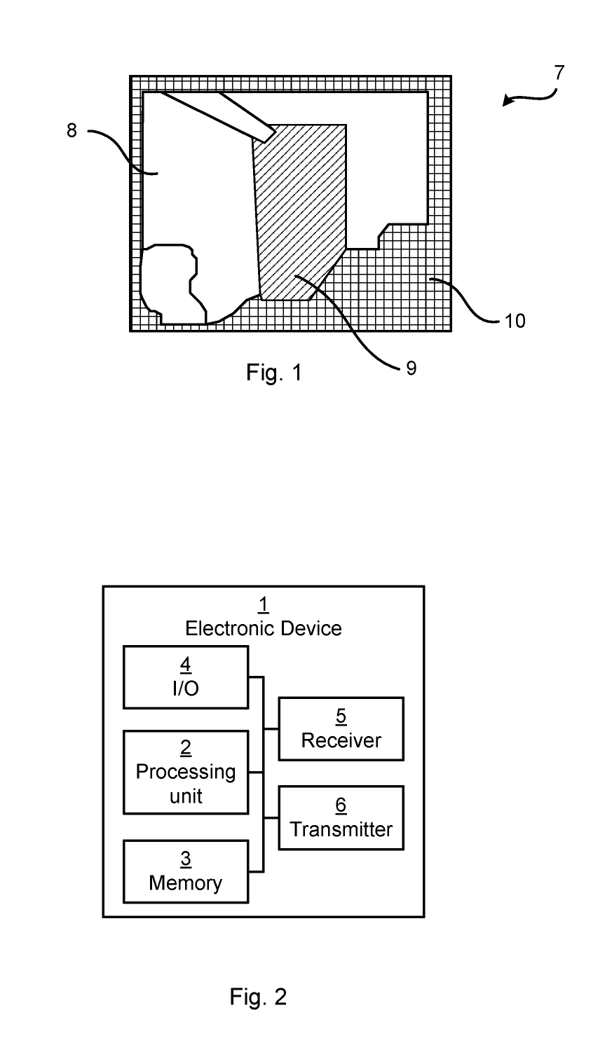

In a step S4 an area 9, 10 in the depth image part 7 is determined. The area 9, 10 in the depth image part 7 is determined by the processing unit 2 of the electronic device 1. The area 9, 10 represents missing depth values in the depth image part. The missing depth values may thus represent non-confident or untrusted depth values in the depth image part. As noted above, in FIG. 1 such areas are identified by reference numerals 9 and 10, where an area with unknown depth values due to objects being located outside the range of the depth sensor is illustrated at reference numeral 9 and one area with unknown depth values within the range of the depth sensor is illustrated at reference numeral 10.

The DHD functional block of the processing unit 2 may thereby detect relevant holes (as defined by the area representing missing depth values) in the depth image part 7 and associated pixels and further select the holes/areas. Assume that the depth map has a depth range between a minimum depth value Zmin and a maximum value Zmax (see FIGS. 3-6 and the description above). As a first example the holes represent content that is out of the range for the depth sensor used to generate the depth image part 7 (as in FIGS. 4-6). That is, according to embodiments, the area 9 represents depth values outside the range of depth map. For example, the depth of the area may be deeper than the maximum depth value. Alternatively the depth of the area may be shallower than minimum depth value. As a second example the holes represent non-reflective surfaces within the range for the depth sensor (as in FIG. 3). That is, according to embodiments, the depth of the area is within the depth range, and the area 10 represents a non-reflective surface in the 3D image. Areas/holes being located too far away from the depth sensor (or too close to the depth sensor) may by the depth sensor be considered as part of the background (e.g. the walls of the room if the sensed scene includes a room having walls) and can be located by different means, as noted above with reference to the different depth sensor types. For example, the depth sensor may return a specific value for pixels in such areas. That is, according to embodiments, in the depth image part 7 depth values of the area 9 have a reserved value. For example a stereo camera may be used in order to estimate the disparity or equivalently the depth inside the hole and check if the estimated depth is outside the range of the depth sensor S. That is, according to embodiments, the depth values are detected by estimating disparity of the area. The holes/areas 10 due to non-reflective surfaces can be found by excluding from the set of detected holes the holes of type 1) and the holes due to disocclusions. The disocclusion holes, on the other hand, can be detected by checking the differences between the original depth map and the depth map that is calibrated (aligned) with the texture image part of the same scene.

A constraint on the minimal size of the hole/area may be added in order to only consider holes/areas at least as large as the minimum size. Likewise a constraint on the shape of the hole/area may be added (e.g. the hole/area should be squared or rectangle etc.). That is, according to embodiments the area 9, 10 is determined exclusively in a case the area 9, 10 is larger than a predetermined size value.

One purpose of the PE is to find an accurate line-based approximation for the regions where a depth map has holes/areas due to the region being outside the range of the depth sensor S or for holes/areas due to the region representing non-reflective surfaces. In a step S6 at least one first line Pr in a first neighbourhood Nr of the area 9, 10 is estimated. The at least one first line Pr is estimated by the processing unit 2 of the electronic device 1. The at least one first line Pr is estimated by determining a first gradient of the depth values Lr in the first neighbourhood Nr and determining a direction of the at least one first line Pr in accordance with the first gradient. FIG. 4 illustrates an example where one line Pr is estimated from the end-point Lr of the area Nr with known depth values. The one line Pr is estimated based on depth values in the neighbourhood Nr and hence the direction of Pr corresponds to the gradient of depth values in the neighbourhood Nr.

According to embodiments, in a step S6′ at least one second line Pl is also estimated in a second neighbourhood Nl of the area 9, 10. The at least one second line Pl is estimated by the processing unit 2 of the electronic device 1. The at least one second line Pl is estimated by determining a second gradient of the depth values Ll in the second neighbourhood Nl and determining a direction of the at least one second line Pl in accordance with the second gradient. According to embodiments the first neighbourhood Nr and the second neighbourhood Nl are located at opposite sides of the area 9, 10.

FIGS. 3, 5, and 6 illustrate examples where one first line Pr is estimated from a first end-point Lr of the area Nr with known depth values and where one second line Pl is estimated from a second end-point Ll of the area Nl with known depth values. In each FIGS. 3, 5, 6 the one first line Pr is estimated based on depth values in a first neighbourhood Nr and hence the direction of Pr corresponds to the gradient of depth values in the first neighbourhood Nr. In each FIGS. 3, 5, 6 the one second line Pl is estimated based on depth values in a second neighbourhood Nl and hence the direction of Pr corresponds to the gradient of depth values in the second neighbourhood Nr.

Thus, first at least one line Pr, Pl is estimated from neighboring Nr, Nl of depth values. Then a plane that fits one (or more) of the at least one line may be estimated. Lines can be taken from the top, middle and bottom area of the hole region, or they can be taken with a regular spacing within the hole etc. Similarly, the number of lines provides a trade-off between estimation complexity and accuracy. According to embodiments the at least one first line is part of a first plane, and/or the at least one second line is part of a second plane.

In a case the at least one first line Pr is a horizontally oriented line the at least one second line Pl may be a vertically oriented line. That is, according to embodiments at least one vertically oriented line is in a step S6″ estimated in a vertically oriented neighbourhood of the area by determining a vertically oriented gradient of the depth values in the vertically oriented neighbourhood and determining a direction of the at least one vertically oriented line in accordance with the vertically oriented gradient. The at least one vertically oriented line is estimated by the processing unit 2 of the electronic device 1.

In a case the at least one first line Pr is a vertically oriented line the at least one second line Pl may be a horizontally oriented line. That is, according to embodiments at least one horizontally oriented line is in a step S6″′ estimated in a horizontally oriented neighbourhood of the area by determining a horizontally oriented gradient of the depth values in the horizontally oriented neighbourhood and determining a direction of the at least one horizontally oriented line in accordance with the horizontally oriented gradient. The at least one horizontally oriented line is estimated by the processing unit 2 of the electronic device 1.

In indoor applications, the camera x-axis is often aligned with the horizon. In such cases the left and the right local planes (represented by the at least one first line Pr and the at least one second line Pl, respectively) may be estimated based on respectively the right Nr and left Nl depth neighborhood of the hole/area 9, 10.

There are different ways to estimate a line Pr, Pl or a plane from a set of 3D points (or depths). One could for instance use a principal component analysis (PCA) approach and consider the main eigenvector to be the desired plane (or line). In order to cope with non-white noise that the neighboring 3D point set can have, a random sample consensus analysis (RANSAC) or an iterative closest point analysis (ICP) approach may be used where the algorithms are initialized with the nearest depths. That is, according to embodiments, a first plane and/or a second plane are/is, in a step S10, estimated by one of principal component analysis, random sample consensus analysis, and iterative closest point analysis. The first plane and/or a second plane are/is estimated by the processing unit 2 of the electronic device 1.

Different weights may also be given to neighboring Nr, Nl depth pixels, depending on the distance from the hole/area 9, 10. That is, according to embodiments, weights are, in a step S12, associated with depth values in the first neighbourhood Nr and/or the second neighbourhood Nl. The weights are associated with depth values in the first neighbourhood Nr and/or the second neighbourhood Nl by the processing unit 2 of the electronic device 1.

The weights may represent a confidence value, a variance or any quality metric. Values of the weights may depend on their distance to the area 9, 10. According to embodiments a first quality measure of a first plane and/or a second quality measure of a second plane is obtained, step S14. The first quality measure is obtained by the processing unit 2 of the electronic device 1. The first plane and/or the second plane may then be accepted as estimates only if the first quality measure and/or the second quality measure are/is above a predetermined quality value, step S16. The first plane and/or the second plane are accepted as estimates by the processing unit 2 of the electronic device 1.

In general, each hole/area 9, 10 may comprise (a) one or more non-sensed walls and/or (b) one or more corner regions. Once a set of lines Pr, Pl or planes is estimated, the PE may be arranged to detect if the number of lines or planes is large enough to generate a good approximation of the content. Therefore, it is, according to an embodiment, determined, in a step S18, whether or not at least one intersection exists between the at least one first line and the at least one second line. The determination is performed by the processing unit 2 of the electronic device 1. Thereby the processing unit 2 may be arranged to check if an intersection C of the first line Pr and second line Pl (for example right and left lines) exists and if so that the intersection is not too far away from the depth sensor S (see, FIG. 6). If the intersection of the two lines does not exist or is far away (e.g. 10*Zmax), then it is determined that there are two intersections (see, FIG. 5). More particularly, as in FIG. 5 two potential corners Clr and Cl may be determined in order to detect a potential new line extending between the two intersections. One way to detect the corners C, Cr, Cl is to detect vertical edges in the corresponding texture image and only keep the long ones close to the left (or right) hole limit Ll (or Lr). That is, according to embodiments a texture image part representing texture values of the 3D image is acquired, step S28. The texture image part representing texture values of the 3D image is acquired by the processing unit 2 of the electronic device 1. In a step S30 at least one edge in the texture image part 7 may be detected. The at least one edge in the texture image part 7 is detected by the processing unit 2 of the electronic device 1. In a step S32 each one of the at least one intersection C, Cr, Cl may be associated with one of the at least one edge. The intersection C, Cr, Cl is associated with one of the at least one edge by the processing unit 2 of the electronic device 1. That is, according to embodiments two edges have been detected. A first plane may extend from the first neighbourhood Pr along the at least one first line Pr to a first Cr of the two intersections. A second plane may extend from the second neighbourhood Nl along the at least one second line Pl to a second Cl of the two intersections. A third plane may extend between the first intersection Cr and the second intersection Cl. The first intersection may be associated with a corner between the first plane and the third plane and the second intersection may be associated with a corner between the second plane and the third plane, step S26. The associations are performed by the processing unit 2 of the electronic device 1. Vertical edges may also be detected in a smoothed and/or reduced resolution image instead of the original image, which could make the detection more robust to edges that are due to objects and not room corners. Another way to detect the room corners is to use the estimated top (or bottom) plane and to detect its horizontal intersection with the potential new plane.

In case (a) the depth of a hole/area may be flat or possibly a linear function of the distance from the depth sensor (see, FIG. 5). More particularly, wherein in a case no intersection is determined, the at least one first line and the at least one second line are, in a step S20, determined to be parallel. The determination is performed by the processing unit 2 of the electronic device 1. The at least one first line Pr and the at least one second line Pl are, in a step S22, associated with a common plane. The association is performed by the processing unit 2 of the electronic device 1. For example, the at least one first line and the at least one second line may be determined to be parallel in case a smallest angle between the at least one first line and the at least one second line is smaller than a predetermined angle value. For example, if two lines (left and right) intersect but the angle between the two lines is small (e.g. <5 degrees) the two lines are determined to be parallel (or close to) and the two lines may be merged and represent one unique plane (e.g. using the mean of the two lines). This approach may also be used for non-reflective surfaces , such as windows, monitors etc, that have a depth very similar or equal to their neighborhood. This embodiment is illustrated in FIG. 3. In this case, the resulting depth map will be similar to a linearly interpolated depth map. Using the left and right neighborhoods enables an accurate line to be obtained.

In case (b) it is reasonable to assume that the depth of hole/area 9 changes with the same gradient as the available depth of neighboring walls (as represented by available depth values in the depth image part 7) that form a corner C (see, FIG. 6). More particularly, wherein in a case one intersection C is determined, the one intersection C is, in a step S24, associated with a corner between the first line Pr and the second line Pl. The association is performed by the processing unit 2 of the electronic device 1. For example, if two lines (left and right) intersect and the angle between the two lines is larger than the predetermined angle value, one left and one right walls (or planes) and their intersection C is determined. In this case the texture image part may be utilized to determine the corner between the two lines (e.g. by vertical edge detection) and the location of the corner C as determined in the texture image may be compared to the theoretical location of the intersection. This approach could be used to refine the lines equations or just to check the consistency of the intersection solution. FIG. 7 schematically illustrates an example of edge detection. In FIG. 7 one edge in the image 12 has been associated with reference numeral 13.

In any of the cases (a), (b), the neighboring pixels with known depth values are used in order to determine one or more local approximation lines for the missing pixels (i.e., the missing depth values).

In other embodiments the PE is arranged not only to estimate left and right planes but also planes from the top and from the bottom of the hole/area 9, 10 using the same steps as disclosed above. Additionally, horizontal lines can be eventually searched in the image 12 and or the depth image part 7 in order to increase the quality of the estimated lines/planes.

Once the at least one first line Pr (alternatively together with the at least one second line Pl) has been estimated, a hole/area filling algorithm is used to fill the holes/areas 9, 10 with estimated depth values. As noted above, the depth map inpainter is arranged to use the lines approximation of the depth of the holes/areas 9, 10 in order to fill the depth map. Therefore, in a step S8, depth values of the area 9, 10 are estimated. The depth values of the area 9, 10 are estimated by the processing unit 2 of the electronic device 1. The depth values of the area 9, 10 are estimated by the processing unit 2 of the electronic device 1. The depth values of the area are estimated based on the at least one first line Pr. The area 9, 10 is filled with the estimated depth values. The 3D image is thereby reconstructed. According to an embodiment depth values of the area 9, 10 based also on the at least one second line Pl are estimated, step S8′. The estimation is performed by the processing unit 2 of the electronic device 1. According to an embodiment depth values of the area based on the at least one vertically oriented line are estimated, step S8″. The estimation is performed by the processing unit 2 of the electronic device 1. According to an embodiment depth values of the area based on the at least one horizontally oriented line are estimated S8″′. The estimation is performed by the processing unit 2 of the electronic device 1. For example, for every pixel of the hole/area, a ray starting from the camera optical center and extending through the image pixel (a method known as back-projection) intersects with the lines in one 3D point per line. Then, the missing depth value for the image pixel may be determined to be the one with the minimum distance from the camera optical center to the line.

The depth map with the filled holes/areas may be filtered to reduce eventual errors, using for instance, a joint-bilateral filter or a guided filter. That is, according to embodiments the depth image part comprising the estimated depth values is, in a step S34, filtered. The processing unit 2 of the electronic device 1 is arranged to filter the depth image part. The at least one first line may be represented by at least one equation where the at least one equation has a set of parameters and values. The step S34 of filtering may then further comprise filtering, step S34′ also the values of the at least one equation. The processing unit 2 of the electronic device 1 is arranged also to filter the values of the at least one equation. Thereby the equations of the lines/planes may also be used to filter the depth values. For instance, the line/planes may be optimized together with the depth map in order to further improve the resulting depth quality.

The electronic device 1 may be arranged to integrate a system that estimates the orientation of the camera (and depth sensor S) with respect to room box approximations in order to determine the corners of the room (angles). That is, according to embodiments an orientation of the depth image part is acquired, step S36. The depth image part is acquired by the processing unit 2 of the electronic device 1. The direction of the at least one first line Pr may then be estimated, in a step S38, based on the acquired orientation. The direction of the at least one first line Pr is estimated by the processing unit 2 of the electronic device 1. This may be accomplished by detecting infinite points from parallel lines or by using an external device such as a gyroscope. That is, according to one embodiment the orientation is acquired, step S36′, by detecting infinite points from parallel lines in the 3D image. According to another embodiment the orientation is acquired, step S36″ from a gyroscope reading. The orientation is acquired by the processing unit 2 of the electronic device 1.

In summary, unlike the above referred paper entitled “Stereoscopic image inpainting using scene geometry” where one plane per color segment is estimated, according to the herein disclosed embodiments the lines are estimated only using neighboring depth pixels with known depth at different locations (on the left, right, top and/or bottom) of the hole/area to be filled.

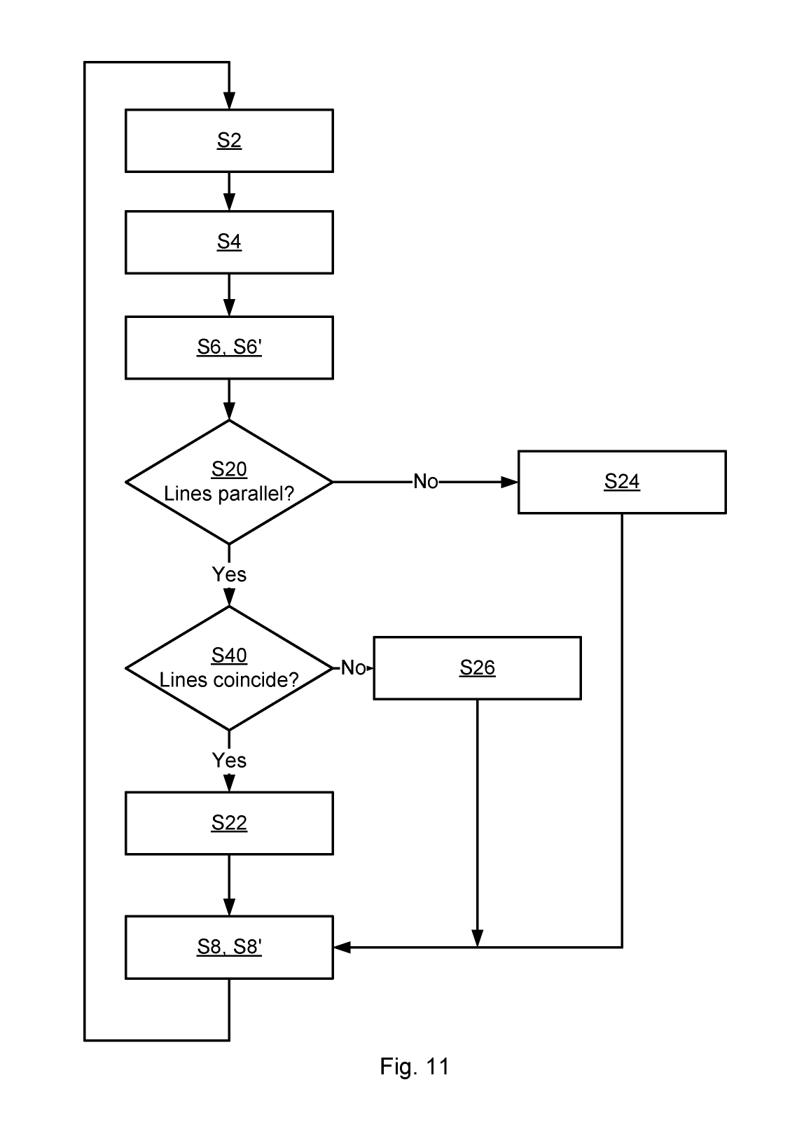

A flow chart according to one exemplary scenario is shown in FIG. 11. In a step S2 a depth image part 7 is acquired by the processing unit 2 of the electronic device 1. In a step S4 an area 9, 10 representing missing depth values in the depth image part 7 is determined by the processing unit 2 of the electronic device 1. At least one first line Pr in a first neighbourhood Nr of the area 9, 10 is estimated as in step S6 by the processing unit 2 of the electronic device 1. At least one second line Pl in a second neighbourhood Nl of the area 9, 10 is estimated as in step S6 by the processing unit 2 of the electronic device 1′. It is by the processing unit 2 of the electronic device 1 determined whether the at least one first line Pr and the at least one second line Pl are parallel as in step S20. If not parallel one corner C may be determined by the processing unit 2 of the electronic device 1 as in step S24. If determined to be parallel it is in a step S40 determined by the processing unit 2 of the electronic device 1 whether or not the at least one first line Pr and the at least one second line Pl are coinciding. If not coinciding two corners Cr, Cl are determined by the processing unit 2 of the electronic device 1 as in step S26. If coinciding a common line for the at least one first line Pr and the at least one second line Pl is determined by the processing unit 2 of the electronic device 1, as in step S22. Based on the found lines depth values of the area 9, 10 are estimated by the processing unit 2 of the electronic device 1 as in steps S8 and S8′. As the skilled person understands, the flow chart of FIG. 11 may be readily combined with either the flowchart of FIG. 9 or the flowchart of FIG. 10.

By knowing the depth sensor setup (calibration) and using the set of estimated lines, the depth can be determined for all missing depth pixels of the hole/area. This filled depth map can then be refined by an optimization or filter framework. The number of lines can vary, from only one to many. For instance, if a hole/area has no right border (image limit), then the left plane (or eventually estimated top and bottom lines) may be used in order to approximate the hole depth. At least one line is necessary to fill the hole/area representing missing depth values with estimated depth values.

The present disclosure has mainly been described above with reference to a few embodiments. However, as is readily appreciated by a person skilled in the art, other embodiments than the ones disclosed above are equally possible within the scope of the disclosure, as defined by the appended patent claims.

1. A method of 3D image reconstruction, comprising:
acquiring a depth image part of a 3D image representation, the depth image part representing depth values of the 3D image;
determining an area in the depth image part, the area representing missing depth values in the depth image part;
estimating at least one first line in a first neighbourhood of the area by determining a first gradient of the depth values in the first neighbourhood and determining a direction of the at least one first line in accordance with the first gradient; and
estimating depth values of the area based on the at least one first line and filling the area with the estimated depth values, thereby reconstructing the 3D image.

2. The method according to claim 1, further comprising:
estimating at least one second line in a second neighbourhood of the area by determining a second gradient of the depth values in the second neighbourhood and determining a direction of the at least one second line in accordance with the second gradient; and
estimating depth values of the area based also on the at least one second line.

3. The method according to claim 2, wherein the first neighbourhood and the second neighbourhood are located at opposite sides of the area.

4. The method according to claim 1, wherein at least one pixel of the first neighbourhood borders the area, and/or wherein at least one pixel of the second neighbourhood borders the area.

5. The method according to claim 1, wherein the at least one first line is part of a first plane, and/or wherein the at least one second line is part of a second plane.

6. The method according to claim 1, further comprising:
estimating the first plane and/or the second plane by one of principal component analysis, random sample consensus analysis, and iterative closest point analysis.

7. The method according to claim 1, further comprising:
associating weights with depth values in the first neighbourhood and/or the second neighbourhood.

8. (canceled)

9. The method according to claim 1, further comprising:
obtaining a first quality measure of the first plane and/or a second quality measure of the second plane; and
accepting the first plane and/or the second plane as estimates only if the first quality measure and/or the second quality measure is above a predetermined quality value.

10. The method according to claim 2, further comprising:
determining whether or not at least one intersection exists between the at least one first line and the at least one second line.

11. The method according to claim 10, wherein in a case no intersection is determined, the method further comprising:
determining the at least one first line and the at least one second line to be parallel; and
associating the at least one first line and the at least one second line with a common plane.

12. The method according to claim 11, wherein the at least one first line and the at least one second line are determined to be parallel in case a smallest angle between the at least one first line and the at least one second line is smaller than a predetermined angle value.

13.-15. (canceled)

16. The method according to claim 1, further comprising:
acquiring a texture image part representing texture values of the 3D image;
detecting at least one edge in the texture image part; and
associating each one of the at least one intersection with one of the at least one edge;
wherein in a case two edges have been detected, wherein a first plane extends from said first neighbourhood along said at least one first line to a first of said two intersections, wherein a second plane extends from said second neighbourhood along said at least one second line to a second of said two intersections, and wherein a third plane extends between said first intersection and said second intersection, the method further comprising:
associating said first intersection with a corner between the first plane and the third plane and said second intersection with a corner between the second plane and the third plane.

17.-26. (canceled)

27. The method according to claim 1, further comprising:
filtering the depth image part comprising the estimated depth values.

28. (canceled)

29. The method according to claim 1, further comprising:
acquiring an orientation of the depth image part; and
estimating the direction of the at least one first line based on the acquired orientation.

30.-31. (canceled)

32. An electronic device for 3D image reconstruction, comprising a processing unit arranged to:
acquire a depth image part of a 3D image representation, the depth image part representing depth values of the 3D image;
determine an area in the depth image part, the area representing missing depth values in the depth image part;
estimate at least one first line in a first neighbourhood of the area by determining a first gradient of the depth values in the first neighbourhood and determining a direction of the at least one first line in accordance with the first gradient; and
estimate depth values of the area based on the at least one first line and filling the area with the estimated depth values, thereby reconstructing the 3D image.

33. The electronic device according to claim 32, wherein the processing unit is further arranged to:
estimate at least one second line in a second neighbourhood of the area by determining a second gradient of the depth values in the second neighbourhood and determining a direction of the at least one second line in accordance with the second gradient; and
estimate depth values of the area based also on the at least one second line.

34. The electronic device according to claim 32, wherein the processing unit is further arranged to:
estimating the first plane and/or the second plane by one of principal component analysis, random sample consensus analysis, and iterative closest point analysis.

35. The electronic device according to claim 32, wherein the processing unit is further arranged to:
associate weights with depth values in the first neighbourhood and/or the second neighbourhood.

36. The electronic device according to claim 32, wherein the processing unit is further arranged to:
obtain a first quality measure of the first plane and/or a second quality measure of the second plane; and
accept the first plane and/or the second plane as estimates only if the first quality measure and/or the second quality measure is above a predetermined quality value.

37. The electronic device according to claim 33, wherein the processing unit is further arranged to:
determine whether or not at least one intersection exists between the at least one first line and the at least one second line.

38. The electronic device according to claim 37, wherein the processing unit is further arranged to, in a case no intersection is determined:
determining the at least one first line and the at least one second line to be parallel; and
associating the at least one first line and the at least one second line with a common plane.

39.-41. (canceled)

42. The electronic device according to claim 32, wherein the processing unit is further arranged to:
acquire a texture image part representing texture values of the 3D image;
detect at least one edge in the texture image part; and
associate each one of the at least one intersection with one of the at least one edge;
wherein in a case two edges have been detected, wherein a first plane extends from said first neighbourhood along said at least one first line to a first of said two intersections, wherein a second plane extends from said second neighbourhood along said at least one second line to a second of said two intersections, and wherein a third plane extends between said first intersection and said second intersection, wherein the processing unit is further arranged to:
associate said first intersection with a corner between the first plane and the third plane and said second intersection with a corner between the second plane and the third plane.

43.-44. (canceled)

45. The electronic device according to claim 32 wherein the processing unit is further arranged to:
filtering the depth image part comprising the estimated depth values.

46. (canceled)

47. The electronic device according to claim 32, wherein the processing unit is further arranged to:
acquire an orientation of the depth image part; and
estimate the direction of the at least one first line based on the acquired orientation.

48-49. (canceled)

50. A computer program product comprising a non-volatile computer readable means on which is stored a computer program for 3D image reconstruction, the computer program comprising computer program code which, when run on a processing unit of an electronic device, causes the processing unit to:
acquire a depth image part of a 3D image representation, the depth image part representing depth values of the 3D image;
determine an area in the depth image part, the area representing missing depth values in the depth image part;
estimate at least one first line in a first neighbourhood of the area by determining a first gradient of the depth values in the first neighbourhood and determining a direction of the at least one first line in accordance with the first gradient; and
estimate depth values of the area based on the at least one first line and filling the area with the estimated depth values, thereby reconstructing the 3D image.

51. (canceled)
